(19) United States
(12) Patent Application Publication
(10) Pub. No.: US 2024/0234726 A1
(43) Pub. Date: Jul. 11, 2024

(54) HIGH CAPACITY LITHIUM ION ANODES AND CELLS AND BATTERIES CONTAINING LITHIUM ION ANODES

(71) Applicant: ADVANCED CELL ENGINEERING, INC., Stuart, FL (US)

(72) Inventors: John Kaufman, Palm City, FL (US); Karim Zaghib, Longueil (CA); Ayyakkannu Manivannan, Stuart, FL (US); Thomas Madden, Stuart, FL (US)

(21) Appl. No.: 18/561,715

(22) PCT Filed: Nov. 8, 2022
(86) PCT No.: PCT/US2022/049324

§ 371 Date: Nov. 16, 2023

Related U.S. Application Data
(60) Provisional application No. 63/277,083, filed on Nov. 8, 2021.
(60) Provisional application No. 63/277,084, filed on Nov. 8, 2021.
(60) Provisional application No. 63/310,979, filed on Feb. 16, 2022.
(60) Provisional application No. 63/340,353, filed on May 10, 2022.
(60) Provisional application No. 63/400,355, filed on Aug. 23, 2022.
(60) Provisional application No. 63/410,538, filed on Sep. 27, 2022.

(51) Int. Cl. H01M 4/583; H01M 4/02; H01M 4/36; H01M 4/38; H01M 4/58; H01M 10/0525; H01M 50/431; H01M 50/457

(52) U.S. Cl. CPC H01M 4/583; H01M 4/364; H01M 4/366; H01M 4/382; H01M 4/386; H01M 4/5825; H01M 10/0525; H01M 50/431; H01M 50/457; H01M 2004/027; H01M 2004/028

(57) ABSTRACT

The present disclosure provides a high capacity lithium ion anode including an anode active material-containing layer having an electrolyte-facing side and a current collector-facing side. The anode active material-containing layer contains a graphite anode active material, a silicon or silicon compound active material, and a lithium reservoir. The anode also contains a current collector. The present disclosure further provides a high capacity lithium ion cell including such an anode, a battery including such a cell, a vehicle battery including such a battery and a method of forming a high capacity lithium ion anode.

### PRIORITY CLAIM

The present application claims priority to U.S. Provisional Patent Application No. 63/277,083, filed Nov. 8, 2021, titled “BIPOLAR LITHIUM ION CATHODES AND CELLS AND BATTERIES CONTAINING LITHIUM ION CATHODES”, U.S. Provisional Patent Application No. 63/400,355, filed Aug. 23, 2022, titled “BIPOLAR LITHIUM ION CATHODES AND CELLS AND BATTERIES CONTAINING LITHIUM ION CATHODES”, U.S. Provisional Patent Application No. 63/277,084, filed Nov. 8, 2021, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/410,538, filed Sep. 27, 2022, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/310,979, filed Feb. 16, 2022, titled “HIGH CAPACITY LITHIUM ION ANODES AND CELLS AND BATTERIES CONTAINING LITHIUM ION ANODES”, and U.S. Provisional Patent Application No. 63/340,353, filed May 10, 2022, titled “SLOT ELECTRODE STACK AND ELECTROCHEMICAL CELLS AND BATTERIES CONTAINING A SLOT ELECTRODE STACK”, each of which is incorporated by reference herein in its entirety.

### TECHNICAL FIELD

The present disclosure relates to high capacity lithium ion anodes, cells, and batteries with high capacity lithium ion anodes with ternary materials: graphite-silicon-lithium as well as methods of forming these anodes, cells, or batteries. These anodes and cells and batteries containing them may exhibit high capacity as compared to similar anodes without modifications of the present disclosure.

### BACKGROUND

Lithium batteries are widely used in consumer electronics due to their relatively high energy density. Rechargeable batteries are also referred to as secondary batteries, and lithium ion batteries are typically secondary batteries. Lithium ion secondary batteries generally have a negative electrode (anode) material that intercalates lithium and a positive electrode (cathode) material, such a lithium cobalt oxide, LiMn₂O₄, having a spinel structure, and LiFePO₄, having an olivine structure, that intercalates and de-intercalates lithium while generally maintaining its crystal structure.

In conventional lithium ion batteries, the cathode material is the source of lithium available for electrochemical reaction. However, during the first charge-discharge cycle of the battery, a portion of the lithium available for electrochemical reaction forms a solid electrolyte interphase (SEI) layer on the anode, resulting in irreversible loss of this lithium and, consequently, a permanent decrease in the capacity of the battery. Furthermore, as the battery continues to cycle, electrolyte reaction and degradation often leads to thickening of the SEI layer and even more loss of available lithium and battery capacity.

### SUMMARY

The present disclosure provides a high capacity lithium ion anode comprising: an anode active material-containing layer having an electrolyte-facing side and a current collector-facing side, the anode active material-containing layer comprising: a graphite anode active material; a silicon or silicon compound active material; and a lithium reservoir; and an anode current collector.

In more specific embodiments, which may be combined with one another and with any other aspects of the present disclosure:
the graphite anode active material comprises graphite particles and the silicon or silicon compound active material comprises silicon or silicon compound particles;
the graphite anode active material comprises a graphite layer and the silicon or silicon compound active material comprises a silicon or silicon compound layer;
the anode active material may further comprise at least one of the following in addition to or in place of graphite or silicon: a natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof;
the lithium reservoir comprises lithium metal particles;
the lithium reservoir comprise a lithium metal sheet;
the lithium reservoir comprise a lithium salt;
the lithium salt is freely dispersed in the anode active material-containing layer;
the lithium salt is coated on the graphite anode active material and the silicon or silicon composition active material;
the lithium salt comprises lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl)imidazole (LiTDI), lithium hexafluorophosphate (LiPF₆), lithium iodide (LiI), or any mixtures or combinations thereof;
the silicon compound comprises SiOₓ in which x≤2;
the graphite anode active material comprises natural graphite, synthetic graphite, or a combination thereof;
the anode further comprises a lithium metal phosphate.

The present disclosure provides high capacity lithium ion cell comprising: any high capacity anode a described above or otherwise herein; a cathode comprising a cathode active material; and an electrolyte.

The present disclosure provides a battery comprising: at least one lithium ion cell as described above or otherwise herein; and a casing.

In more specific embodiments, which may be combined with any other aspects of the present disclosure: the battery is a cylindrical cell, a pouch cell, or a prismatic cell.

The present disclosure provides a battery module or pack, such as an electric vehicle battery comprising: at least one battery as described above or otherwise herein; a positive connector; a negative connector; and a housing.

In more specific embodiments, which may be combined with any other aspects of the present disclosure: the vehicle battery further comprises safety equipment, control equipment, or any combinations thereof.

### BRIEF DESCRIPTION OF THE DRAWINGS

The disclosure may be better understood through reference to the following figures, which are not to scale, which depict embodiments of the present disclosure, and in which:

FIG. 1 is a schematic cross-sectional diagram of a cell having a high capacity lithium ion anode;

FIG. 2 is a schematic, cut-away elevation view diagram of a cylindrical battery having a jelly-roll configuration and including a high capacity lithium ion anode from FIG. 1;

FIG. 3 is a schematic, partially cross-sectional elevation view diagram of a prismatic cell battery including a high capacity lithium ion anode from FIG. 1;

FIG. 4 is a schematic diagram of an electric vehicle battery including a battery module or pack, including prismatic cell batteries of FIG. 3;

FIG. 5A is a schematic cross-sectional diagram of a lithium ion graphite-silicon particle anode without a lithium reservoir;

FIG. 5B is a schematic cross-sectional diagram of a lithium ion graphite-silicon particle anode with a lithium metal sheet located on the electrolyte-facing side of the anode active material-containing layer;

FIG. 5C is a schematic cross-sectional diagram of a lithium ion graphite-silicon particle anode with a lithium metal sheet located on the current collector-facing side of the anode active material-containing layer;

FIG. 5D is a schematic cross-sectional diagram of a lithium ion graphite-silicon particle anode with a lithium metal particles located on the electrolyte-facing side of the anode active material-containing layer;

FIG. 5E is a schematic cross-sectional diagram of a lithium ion graphite-silicon particle anode with a lithium metal particles located on the current collector-facing side of the anode active material-containing layer;

FIG. 5F a schematic cross-sectional diagram of a lithium ion graphite-silicon particle anode with a lithium salt freely dispersed in the anode active material-containing layer;

FIG. 5G a schematic cross-sectional diagram of a lithium ion graphite-silicon particle anode with a lithium salt coated on the graphite and silicon particles of the anode active material-containing layer;

FIG. 6A is a schematic cross-sectional diagram of a lithium ion graphite-silicon layered anode with an electrolyte-facing silicon layer without a lithium reservoir;

FIG. 6B is a schematic cross-sectional diagram of a lithium ion graphite-silicon layered anode with an electrolyte-facing silicon layer with a lithium metal sheet located on the electrolyte-facing side of the anode active material-containing layer;

FIG. 6C is a schematic cross-sectional diagram of a lithium ion graphite-silicon layered anode with an electrolyte-facing silicon layer with a lithium metal sheet located on the current collector-facing side of the anode active material-containing layer;

FIG. 6D is a schematic cross-sectional diagram of a lithium ion graphite-silicon layered anode with an electrolyte-facing silicon layer with a lithium metal particles located on the electrolyte-facing side of the anode active material-containing layer;

FIG. 6E is a schematic cross-sectional diagram of a lithium ion graphite-silicon layered anode with an electrolyte-facing silicon layer with a lithium metal particles located on the current collector-facing side of the anode active material-containing layer;

FIG. 7A is a schematic cross-sectional diagram of a lithium ion graphite-silicon layered anode with an electrolyte-facing graphite layer without a lithium reservoir;

FIG. 7B is a schematic cross-sectional diagram of a lithium ion graphite-silicon layered anode with an electrolyte-facing graphite layer with a lithium metal sheet located on the electrolyte-facing side of the anode active material-containing layer;

FIG. 7C is a schematic cross-sectional diagram of a lithium ion graphite-silicon layered anode with an electrolyte-facing graphite layer with a lithium metal sheet located on the current collector-facing side of the anode active material-containing layer;

FIG. 7D is a schematic cross-sectional diagram of a lithium ion graphite-silicon layered anode with an electrolyte-facing graphite layer with a lithium metal particles located on the electrolyte-facing side of the anode active material-containing layer;

FIG. 7E is a schematic cross-sectional diagram of a lithium ion graphite-silicon layered anode with an electrolyte-facing graphite layer with a lithium metal particles located on the current collector-facing side of the anode active material-containing layer;

FIG. 8A is an anode in a lithiation apparatus during a liquid lithiation process; and

FIG. 8B is an anode in a lithiation apparatus during a high temperature lithiation process.

### DETAILED DESCRIPTION

The present disclosure relates to high capacity lithium ion anodes, cells, and batteries with high capacity lithium ion anodes as well as methods of forming these anodes, cells, or batteries. These high capacity lithium ion anodes generally include a graphite-silicon composition as the anode active material along with a lithium reservoir. The lithium reservoir, in various embodiments, may be lithium metal present in the anode, but not intercalated in the graphite-silicon composition, such as lithium particles or foil, or a lithium salt present in the anode as either free lithium salt or coated on the graphite-silicon composition, or any combinations thereof. It will be understood by one of skill in the art that these initial anode structures exist prior to cell or battery assembly and/or prior to cycling, e.g. in an uncycled cell or battery assembly.

As used herein following terms are ascribed the following meanings:

Chemical abbreviations are employed as is typical in the art. For example, a lithium ion may be designated as Li+ and an electron may be designated as e−. Weight % may be abbreviated as “wt %.”

A “cathode” (which may also be referred to as a “positive electrode”) is the electrode to which, during discharge of a lithium ion electrochemical cell, electrons flow and combine with lithium ion (typically in the context of a metal oxide insertion or de-insertion g the lithium ion). During charge of the electrochemical cell, electrons flow from the cathode and lithium ions are also released from the cathode.

A “cathode active material” is a chemical that undergoes electrochemical reaction in the cathode to exchange lithium ions and electrons with other components of the electrochemical cell.

A “bipolar cathode” is a cathode including two different layers that differ in their cathode active material compositions and, thus, also in their energy density and power density. In the simplest version of a bipolar cathode, a first layer contains a first cathode active material and the second layer contains a second cathode active material, which differs in chemical composition and at least one electrochemical property from the first cathode active material. “Bipolar cathode” does not denote a conventional bipolar battery stack configuration.

An “anode” (which may also be referred to as a “negative electrode”) is the electrode from which, during discharge of a lithium ion electrochemical cell, electrons flow and from which lithium ions are released. During charge of the electrochemical cell, electrons flow to the anode, where they combine with lithium ion, often to form lithium metal (Li).

An “anode active material” is a chemical that undergoes electrochemical reaction in the anode to exchange lithium ions and electrons with other components of the electrochemical cell, or upon which lithium metal may be plated or removed as lithium ions and electrons are separated and recombined by the electrochemical reaction.

A “current collector” is a component of the cathode or anode that exchanges electrons directly or indirectly with the active material to allow the electrochemical reaction to proceed.

An “electrolyte” is a substance that can exchange lithium ions with the cathode and anode. Although many examples in the present specification relate to liquid electrolytes, suitable non-liquid electrolytes, such as gel or solid electrolytes, may also be used in electrochemical cells encompassed by the present disclosure.

A “cell” or “electrochemical cell” is a basic physical unit in which a complete electrochemical reaction may occur if the cell is electrically connected to an external energy sink or energy source. An electrochemical cell includes a cathode, and anode, and an electrolyte. Unless the electrolyte forms an electrically non-conductive barrier between the anode and cathode, the electrochemical cell also contains a separator that forms an electrically non-conductive barrier between the anode and cathode. An electrochemical cell also includes a container that maintains the electrochemical cell as a physical unit, such as by containing a liquid electrolyte, excluding air or water from the cell, or protecting the cell components from physical damage.

A “battery” is a more complex physical unit that includes at least one electrochemical cell combined with at least one other component not a part of the electrochemical cell, such as a housing or a second or more electrochemical cells. A battery may also include other components, such as vents, air circulation systems, fire suppression systems, electrical conductors, such as wiring or bars, identification components, and even a processor and associated memory, which may for example, assess battery status and control battery functions.

“Uncycled” refers to a cell or battery that has never been charged and discharged or to an anode or cathode or an anode active material or cathode active material that has never been charged and discharged in a cell or battery.

“Hard carbon” is a solid form of carbon that cannot be converted to graphite by heat-treatment at temperatures up to 3000° C. and may also be referred to as “non-graphitizing carbon” as a result. Hard carbon may be formed by heating a suitable carbon-based precursor to 1000° C. in the absence of oxygen.

Unless otherwise specified, the term “including” is used in the expansive sense and means “not limited to.” Likewise, “or” is used expansively and means both one of the listed options and combination of more than one of the listed options (i.e. and/or). “A” “an,” and “the” include more than one. “About,” as used herein, means within a variation of 1%.

Numerical designations followed by a and b indicate similar components that may collectively be referred to by the numeral only.

All lists items disclosed herein should be interpreted as including any combinations thereof unless otherwise specified.

All bounded and unbounded ranges recited herein should be interpreted as including both all values between the endpoint values (or above or below the endpoint value, as the case may be, for unbounded ranges) and the endpoint values. The terms “in a range from” and “between” both include endpoint values.

### High Capacity Anode Cells

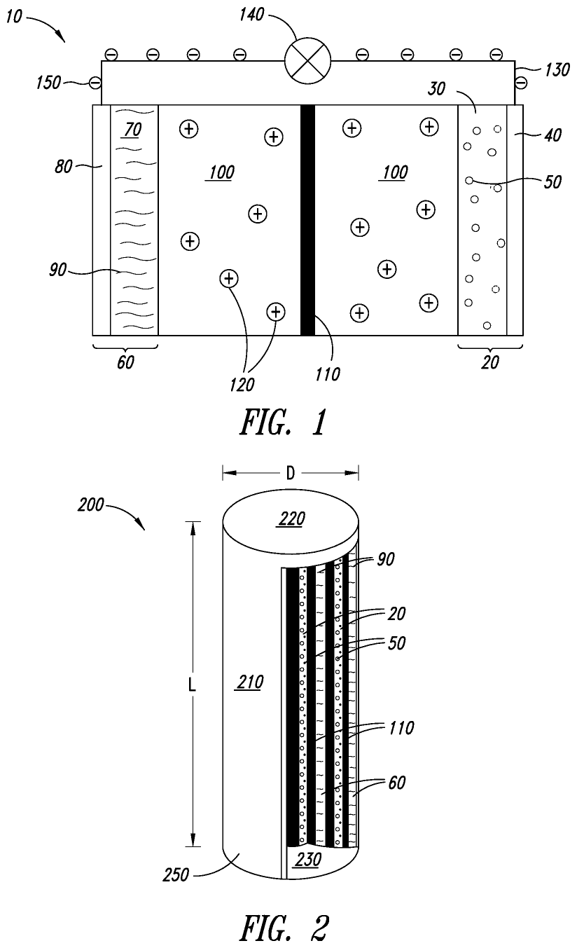

Referring now to FIGS. 1-4, the present disclosure, according to some embodiments, provides an electrochemical cell 10, which may be in a battery, for example battery 200, battery 300, or battery 500. The electrochemical cell 10 includes a cathode 20, a high capacity anode 60, and an electrolyte 100.

Cathode 20 includes at least one cathode active material-containing layer 30 that contains at least one cathode active material 50. Cathode 20 further includes cathode current collector 40.

Anode 60 includes anode active material-containing layer 70 that contains anode active materials 90a (graphite) and 90b (silicon or silicon compound). Anode 60 also includes anode current collector 80.

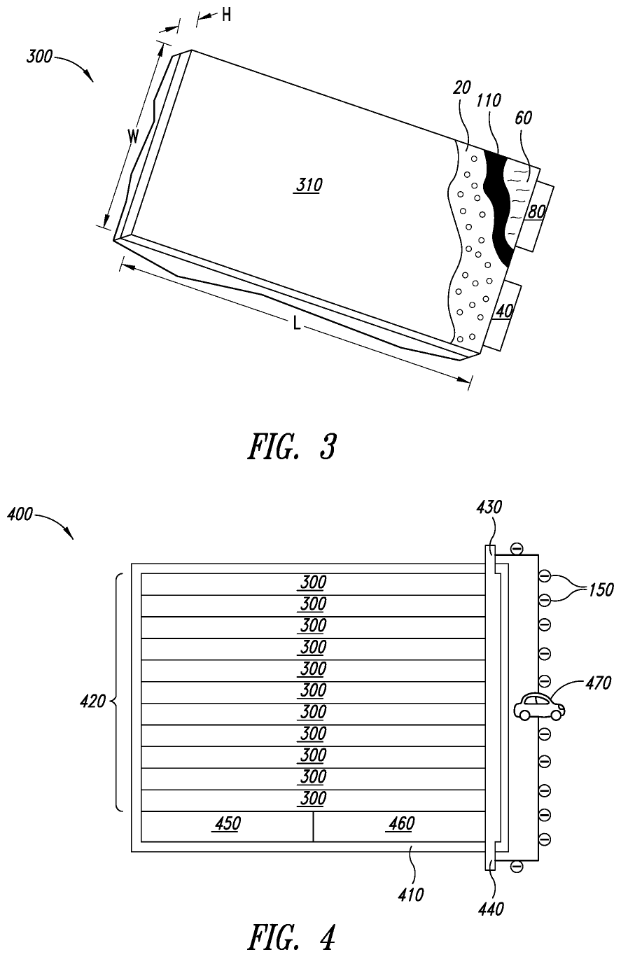

Electrolyte 100 contains lithium ions 120. In some embodiments, not shown, the electrochemical cell 10 includes a solid electrolyte 100. Solid electrolyte 100 may include a dried or crosslinked form of the polymer matrix. In other embodiments, such as those depicted in FIGS. 2 and 3, electrochemical cell 10 includes a liquid electrolyte.

Separator 110 electrically insulates cathode 20 from anode 60 within electrochemical cell 10. Separator 110 allows at least lithium ions 120 to pass through it. In some embodiments, the separator 110 includes polyethylene, polypropylene, a ceramic-coated polymer composite, or any combinations thereof. In more specific embodiments, the separator is a polyethylene-polypropylene-polyethylene tri-layer membrane.

In some embodiments, the separator 110 further includes an electrically insulative material, such as glass. In a specific embodiment, the separator 100 may include glass fibers, particularly glass fibers formed into a porous mat.

In some embodiments, the separator 110 is coated on one or both sides with a ceramic material In more specific embodiments, the ceramic material includes oxide ceramic, sulfide, Al₂O₃, Al₂O₃—SiO₂, or any combinations thereof.

Electrochemical cell 10, when connected to electrically conductive external circuit 130, allows electrons 150 to pass through external circuit 130 from the anode to the cathode or vice versa.

In the example depicted in FIG. 1, electrochemical cell 10 is being discharged to power external load 140. If electrochemical cell 10 were being charged, an energy source, such as an AC wall outlet (converted to DC power), would be in place of external load 140.

The voltage of any electrochemical cell according to the present disclosure is the difference between the half-cell potentials at the cathode and the anode, and the cathode active materials and anode active material(s) may be chosen accordingly. The electrolyte may be chosen to avoid or decrease the amount of degradation at the cell voltage.

### High Capacity Anode

Anode 60, as depicted in FIGS. 1-8, includes anode active materials 90a (graphite) and 90b (silicon) in an anode active material layer 70. In some embodiments, anode layer 70 may be formed entirely of anode active material 90. In other embodiments, an additional material, such as a conductivity enhancer or binder may be present. In some more specific embodiments, the anode active material may also be or include a combination of hard carbon and amorphous silicon and/or silicon nanotubes.

In some embodiments, the anode active material may further comprise at least one of the following in addition to or in place of graphite or silicon: natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof. In some embodiments, the anode active material 90, even with the above additions or substitutions still contains at least one of graphite or silicon.

In some embodiments, the graphite anode active material 90a may be present in a weight % (wt %) as compared to total anode active material weight between about 5 wt % and about 99 wt %, including ranges therein with endpoints of about 10, 15, 20, 25, 30, 35, 40, 45, 50, 55, 60, 65, 70, 75, 80, 85, 90, 92, 95, 98 wt %. In some more specific embodiments, the graphite anode active material 90a may be present in a weight % (wt %) as compared to total anode active material weight between about 92 wt % and 99 wt %, including ranges therein with endpoints of about 92, 93, 94, 95, 96, 97, 98 wt %. %. In some more specific embodiments, the graphite anode active material 90a may be present in a weight % (wt %) as compared to total anode active material weight between about 85 wt % and 99 wt %, including ranges therein with endpoints of about 86, 87, 88, 90, 91, 92, 93, 94, 95, 96, 97, 98 wt %.

In some embodiments, the graphite anode active material 90a may be a synthetic graphite, a natural graphite, or a combination thereof. If the graphite anode active material 90a is a combination of synthetic graphite and natural graphite, the synthetic graphite may be present in a weight % (wt %) as compared to total graphite anode active material 90a weight between about 5 wt % and about 95 wt %, including ranges therein with endpoints of about 10, 15, 20, 25, 30, 35, 40, 45, 50, 55, 60, 65, 70, 75, 80, 85, 90 wt %.

In some embodiments, the silicon anode active material 90b may be elemental silicon (also referred to herein as simply “silicon”), a silicon compound, particularly SiOₓ in which x<2, or in which x≤2, or any combinations thereof. If the silicon anode active material 90b is a combination of silicon and a silicon compound, the silicon may be present in a weight % (wt %) as compared to total silicon anode active material 90b weight between about 5 wt % and about 95 wt %, including ranges therein with endpoints of about 10, 15, 20, 25, 30, 35, 40, 45, 50, 55, 60, 65, 70, 75, 80, 85, 90 wt %. If the silicon anode active material 90b contains a silicon compound, SiOₓ i) in which x<2, or ii) in which x≤2 may be present in a weight % (wt %) as compared to total SiOₓ anode active material 90b weight between about 5 wt % and about 95 wt %, including ranges therein with endpoints of about 10, 15, 20, 25, 30, 35, 40, 45, 50, 55, 60, 65, 70, 75, 80, 85, 90 wt %. If specific embodiments, the silicon compound may be SiOₓ in which x<2.

In some embodiments, the following reaction may occur with silicon in the anode 60: (SiO+Li→Li₂O+Li×Si LizO) (ICL).

In some embodiments, the silicon may be present in the form of particles. In a more specific embodiment, the particles are nanoparticles and may have an average longest dimension (such as diameter for spherical particles, or length for cylindrical particles) that is 900 nm, 750 nm, 500 nm, 250 nm, 100 nm, 50 nm, or 10 nm or less, or in a range of 0.1 nm to 900 nm, 0.1 nm to 750 nm, 0.1 nm to 500 nm, 0.1 nm to 250 nm, 0.1 nm to 100 nm, 0.1 nm to 50 nm, or 0.1 nm to 10 nm. In some embodiments, the silicon in the anode may include between 5% and 50% silicon nanoparticles by weight. Anodes containing silicon nanoparticles may have lower volume expansion during cycling than anodes containing silicon microparticles.

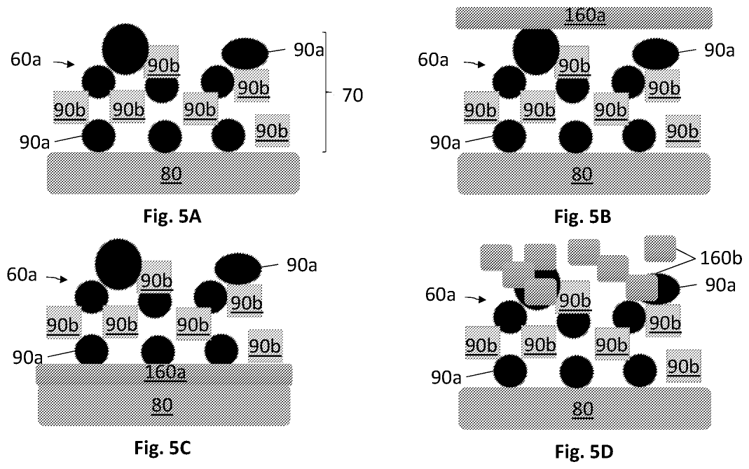

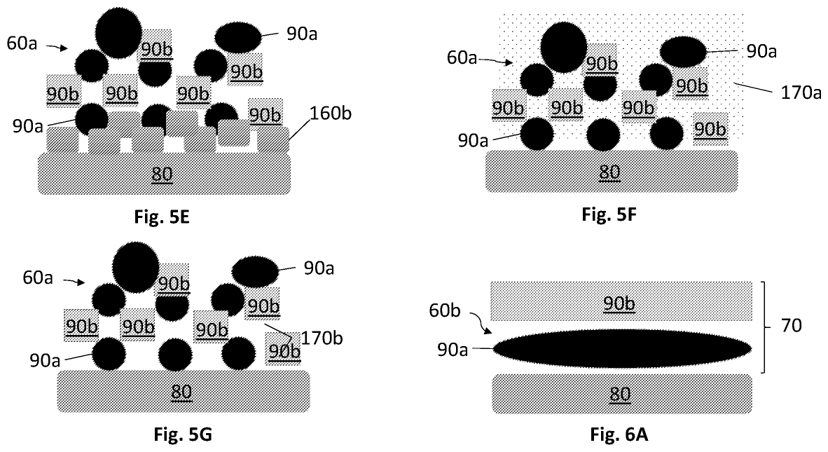

The anode active material-containing layer 70 additional includes a lithium reservoir, which contains lithium metal 160 or lithium salt 170 not intercalated in the graphite or silicon anode active materials 90 in an uncycled electrochemical cell 10. The lithium reservoir may be located relative to anode active material-containing layer 70 in a variety of ways. For example, the lithium reservoir may be located primarily at the electrolyte-facing portion of the anode active material-containing layer 70, as illustrated in FIGS. 5B, 5D, 6B, 6D, 7B, and 7D. The lithium reservoir may be located primarily at the current collector-facing side of the anode active material-containing layer 70, as illustrated in FIGS. 5C, 5E, 6C, 6E, 7C, and 7E. The lithium reservoir may also be located throughout the anode active material-containing layer 70, as illustrated in FIGS. 5F and 5G.

In some embodiment, prior to cycling the anode active material-containing layer 70 may include up to 20% lithium metal by weight, up to 15% lithium metal by weight, up to 10% lithium metal by weight, lithium metal in a range of 1% to 20% by weight, 1% to 15% by weight, 1% to 10% by weight, 5% to 20% by weight, 5% to 15% by weight, or 5% to 10% by weight.

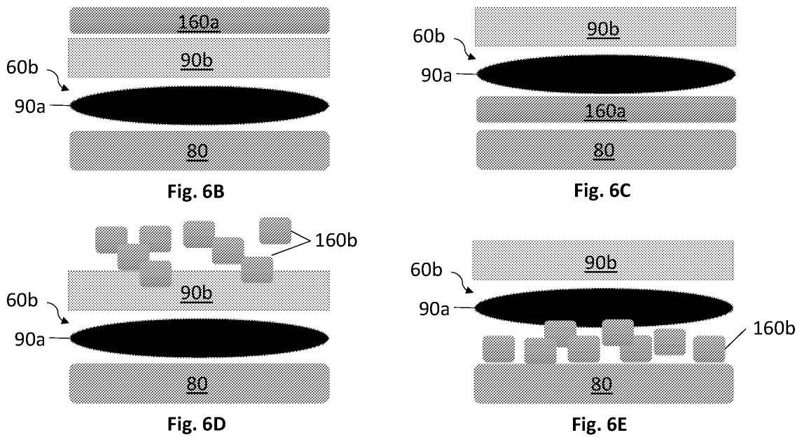

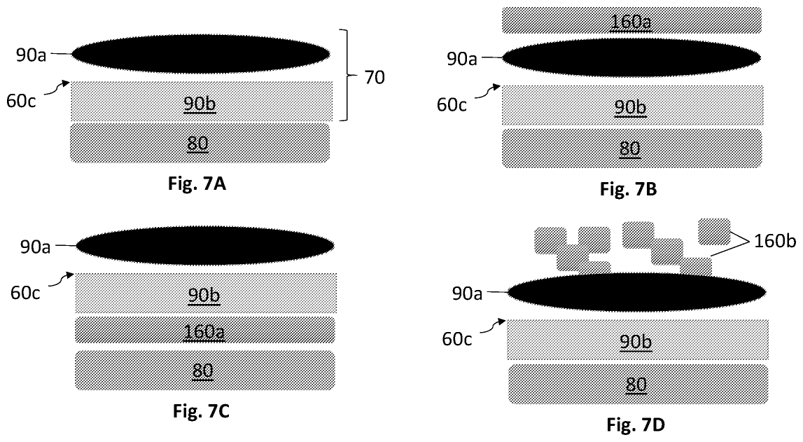

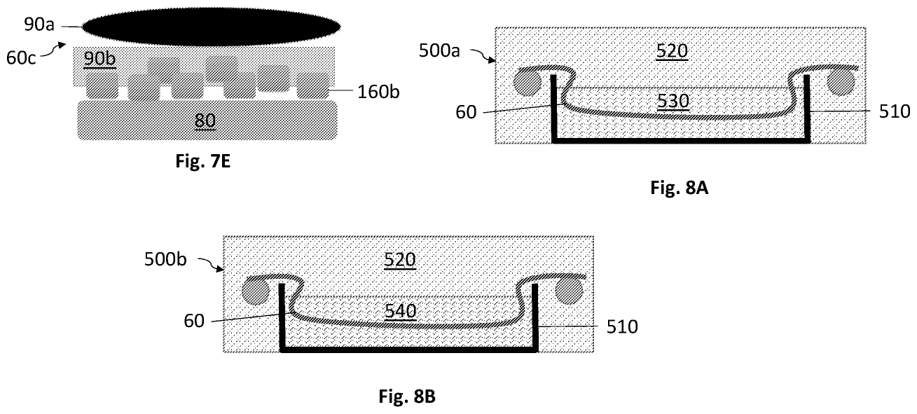

Anode active material-containing layer 70 may also be structured in a variety of ways. For example, it may be formed from graphite particles and silicon or silicon compound particles. These particles may be mixed as illustrated in FIGS. 5A-5G. In some embodiments, they may be homogenously mixed. In other embodiments, not shown, the particles may be mixed, but with a gradient of particle types throughout the anode active material-containing layer 70, such as a gradient from the current collector-facing side to the electrolyte-facing side. In still other embodiments, also not shown, but similar in structure to FIGS. 6A-E and FIGS. 7A-E, the graphite particles may be deposited in a graphite layer and the silicon or silicon compound particles may be deposited in a silicon layer.

In some embodiments, the graphite particles may be of a uniform diameter, such that 90% of the particles have a diameter within 10% of the average particle diameter. In other embodiments, the graphite particles may be of two distinct, uniform sizes. For example, the graphite particles may have a first uniform size with an average diameter at least 1.5, 2, 2.5, 3, 5, 10, or 20 times the average diameter of graphite particles of the second uniform size.

In some embodiments, the silicon or silicon compound particles may be of uniform diameter, such that 90% of the particles have a diameter with 10% of the average particle diameter. In other embodiments, the silicon or silicon compound particles may be of two distinct, uniform sizes. For example, the silicon or silicon compound particles may have a first uniform size with an average diameter at least 1.5, 2, 2.5, 3, 5, 10, or 20 times the average diameter of silicon or silicon compound particles of the second uniform size.

More specifically, FIG. 5A illustrates the basic structure of an anode 60 with an anode active material-containing layer 70 containing graphite particles 90a and silicon particles 90b, in the absence of a lithium reservoir. The anode active material-containing layer 70 is adjacent the current collector 80. FIGS. 5B and 5C illustrate an anode 60 with the same basic structure as that of FIG. 5A, but with a lithium metal sheet 160a lithium reservoir. In FIG. 5B, the lithium metal sheet 160a is located on the electrolyte-facing side of the anode active material-containing layer 70. In FIG. 5C, the lithium metal sheet 160a is located on the current collector-facing side of the anode active material-containing layer 70. FIGS. 5D and 5E also illustrate an anode 60 the same basic structure as that of FIG. 5A, but with lithium metal particles 160b as the lithium reservoir. In FIG. 5D, the lithium metal particles 160b are located on the electrolyte-facing side of the anode active material-containing layer 70. In FIG. 5E, the lithium metal particles 160b are located on the current collector-facing side of the anode active material-containing layer 70.

Anode active material-containing layer 70 may also be structured in the form of graphite and silicon or silicon compound layers, which may be continuous sheets of material as illustrated in FIGS. 6A-6E and 7A-7E. The layers may be composed primarily of physically integral graphite, silicon, or silicon compound, or they may include additives, such as binders or other additives to form the layer or maintain its physical integrity. FIGS. 6A and 7A illustrate the basic structure of an anode 60 with an anode active material-containing layer 70 containing graphite layer 90a and silicon or silicon compound layer 90b, in the absence of a lithium reservoir. The anode active material-containing layer 70 is adjacent the current collector 80. In FIG. 6A, the silicon or silicon compound layer 90b is located on the electrolyte-facing side of the anode active material-containing layer 70. In FIG. 7A, the graphite layer 90a is located on the electrolyte-facing side of the anode active material-containing layer 70. In FIGS. 6B and 7B, the lithium metal sheet 160a is located on the electrolyte-facing side of the anode active material-containing layer 70. In FIGS. 6C and 7C, the lithium metal sheet 160a is located on the current collector-facing side of the anode active material-containing layer 70. In FIGS. 6D and 7D, the lithium metal particles 160b are located on the electrolyte-facing side of the anode active material-containing layer 70. In FIGS. 6E and 7E, the lithium metal particles 160b are located on the current collector-facing side of the anode active material-containing layer 70.

In embodiments containing lithium metal particles, these particles may include a coating that inhibits reaction of lithium metal with oxygen or water.

Although the figures illustrate embodiments with only single layers of lithium reservoir, in some embodiments, multiple layers may also be present in the anode 60. In addition, although the figures illustrate embodiments with only single graphite or silicon or silicon compound layers, multiple layers may be present in the anode 60.

In some embodiments, the lithium reservoir is in the form of a lithium salt 170. As illustrated in FIG. 5F, the lithium salt 170a may be freely dispersed in the anode active material-containing layer 70. As illustrated in FIG. 5G, the lithium salt 170b may be coated on the graphite particles 90a and silicon or silicon compound particles 90b of the anode active material-containing layer 70. In embodiments, similar to those illustrated in FIGS. 6A and 7A, in which graphite layer 90a and silicon or silicon compound layer 90b are present, the lithium salt 170a may still be freely dispersed in the anode active material-containing layer 70 by being dispersed between the layers, or the lithium salt 170b may be coated on the graphite layer 90a and the silicon or silicon compound layers 90b. In some embodiments, both the graphite active material 90a and the silicon or silicon compound active material 90b are coated with lithium salt 170a.

The lithium salt 170 may, in particular embodiments, be lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl)imidazole (LiTDI), lithium hexafluorophosphate (LiPF₆), lithium iodide (LiI), or any mixtures or combinations thereof, particularly 1-Butyl-3-methylimidazolium bis(trifluoromethanesulfonyl) imide combined with LiTFSI. The lithium salt 170 may further include compounds to enhance electrode stability by impeding the reaction of lithium with oxygen, particularly under normal atmosphere, such as an organic polymer coating.

Suitable additional materials that may be present in anode 60 include polymer binders, conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the anode active material-containing layer 70 may include 5 wt % or less conductivity enhancer. More specifically, the anode active material-containing layer 70 may include between about 1 wt % and about 5 wt %, between about 2 wt % and about 5 wt %, about 1 wt % and about 4 wt %, about 2 wt % and about 4 wt %, or about 3 wt % and about 4 wt % conductivity enhancer.

Suitable polymer binders include binders that adhere the anode active materials or lithium reservoir to other components of the anode 60, such as the other layers or particles, as the case may be, or the current collector 80. In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber/carboxyl methyl-cellulose (SBR/CMC), sodium alginate, or sodium acrylate, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In some embodiments, the anode active material-containing layer 70 may include 5 wt % or less polymer binder. More specifically, the anode active material-containing layer 70 may include between about 1 wt % and about 5 wt %, between about 2 wt % and about 5 wt %, about 1 wt % and about 4 wt %, about 2 wt % and about 4 wt %, or about 3 wt % and about 4 wt % polymer binder.

In some embodiments, the anode active material-containing layer 70 may include 5 wt % or less, 3 wt % or less, between 0.5 and 5 wt %, between 1 and 5 wt %, between 0.5 and 3 wt %, or between 1 and 3 wt % lithium metal phosphate cathode material, with may be the same as or different from the cathode material in the cell.

In some embodiments, a third, fourth, or more anode active material may also be present.

Anode 60 may include an anode current collector 80, which may be any suitable electrically conductive material, such as a metal foil, a metal grid, a metal screen, metal foam, or expanded metal (which is a metal grid or metal screen that has a thickness sufficient to allow a substantial amount of cathode active material to collect within it) or at least one graphene layer, typically a plurality of graphene layers. In some embodiments, anode current collector 80 may include Ni, Ti, C, Cu, stainless steel, or any combinations thereof. In a specific embodiment, the anode current collector 80 is copper, more specifically copper foil. In some embodiments, if the current collector includes or is a metal, it may further include a conductive and corrosion-resistant coating, such as TiN.

In some embodiments, the anode active material-containing layer 70 has a thickness of between about 2 microns and about 8 microns, about 2 microns and about 6 microns, 5 about 2 microns and about 4 microns, about 4 microns and about 8 microns, about 4 microns and about 6 microns, about 6 microns and about 8 microns, or about 2 microns and about 100 microns.

In some embodiments, not shown, the anode 60 may have an anode active material-containing layer 70 on both sides of the current collector 80. In a more specific embodiment, such an anode 60 has a thickness of between about 2 microns and about 1000 microns, about 2 microns and about 8 microns, about 2 microns and about 6 microns, about 2 microns and about 4 microns, about 4 microns and about 8 microns, about 4 microns and about 6 microns, about 6 microns and about 8 microns, about 2 microns and about 500 microns, or about 2 microns and about 100 microns. In some embodiments, the anode layer 70 has a total anode active material 90 loading of between about 1 mg/cm² and about 100 mg/cm² total or per side, if both sides have cathode active material.

In some embodiments, the anode layer 70 has a density of between about 0.5 g/mL and about 3 g/mL, about 0.5 g/mL and about 2.5 g/mL, about 0.5 g/mL and about 2 g/mL, about 1 g/mL and about 3 g/mL, about 1 g/mL and about 2.5 g/mL, about 1 g/mL and about 2 g/mL, about 1 g/mL and about 100 g/mL, more specifically between about 1 g/mL and about 75 g/mL, about 1 g/mL and about 50 g/mL, about 1 g/mL and about 25 g/mL, about 25 g/mL and about 100 g/mL, about 25 g/mL and about 75 g/mL, about 25 g/mL and about 50 g/mL, about 50 g/mL and about 100 g/mL, about 50 g/mL and about 75 g/mL, or about 75 g/mL and about 100 g/mL.

In some embodiments, the anode 60 or anode active material-containing layer 70 may exhibit a loss of lithium of less than 1% by weight, or in a range of 0.001% to 1% by weight after 100 cycles.

### Cathodes

The cathode active material 50 may be any active material compatible with a graphite-silicon anode, or any combination of such active materials. In some embodiments the cathode active material 50 may be a lithium compound, such as a lithium metal oxide (LMO) or lithium metal phosphate (LMP).

The cathode active material may generally be present in a crystalline, and not amorphous, form. In particular, the lithium metal oxides may be those that exhibit a layered crystal structure, similar to that of lithium cobalt oxide, more particularly a rhombohedral lattice, hexagonal class crystal structure, such as that of space group R-3m. The lithium metal phosphates may be those that exhibit an orthorhombic crystal structure of space group Pnma, sometimes referred to as an olivine structure. Some cathode active materials may have spinel structure.

The cathode active material 50 may be in the form of particles, which may be nanoparticles, microparticles, or agglomerates. Particle size includes any coating on cathode active materials. Where multiple cathode active material are present, cathode active materials may have about the same particle size or different particle sizes and similarly may be agglomerated or non-agglomerated, or one particle type may be agglomerated while the other is not.

In specific embodiments, the cathode active may include lithium cobalt oxide (LiCoO₂), lithium nickel aluminum oxide (LiNi/Al/O₂), lithium nickel manganese cobalt oxide (LiNi/Mn/CoO₂, also referred to as “NMC”), particularly in which Ni is present in at least 50 wt % of the total weight of Ni, Mn, and Co, lithium nickel cobalt aluminum oxide (LiNi/Co/AlO₂, also referred to as “NCA”), lithium nickel manganese cobalt aluminum oxide (LiNi/Mn/Co/AlO₂, also referred to as NMCA), lithium iron phosphate (also referred to as “LFP”), lithium manganese iron phosphate (also referred to as “LMFP”), lithium manganese nickel iron phosphate (also referred to as “LMNFP”), lithium iron cobalt phosphate (also referred to as “LFCP”), or lithium iron manganese cobalt phosphate (also referred to as “LFMCP”), in any combinations.

In specific embodiments, NMC contains Ni in an amount that is at least 50 wt % of the total weight of Ni, Mn, and Co.

In other specific embodiments, the cathode may include a combination of two or more NMCs that differ in their respective relative amounts of Ni, Mn, and Co.

In some embodiments, the cathode may contain one or a mixture of cathode active materials.

In some embodiments, the cathode, when in an uncycled state, also contains an unlithiated metal oxide, such as an unlithiated metal phosphate in addition to the lithiated materials. In some embodiments, the unlithiated metal oxide has the same chemical composition as the lithiated metal oxide, but without lithium (e.g. LiFePO₄ and FePO₄). In other embodiments, the unlithiated metal oxide has a different chemical composition than the lithiated metal oxide (e.g. LiFePO₄ and MnFePO₄ or LiMn_{0.2}Fe_{0.8}PO₄ and Mn_{0.15}Fe_{0.85}PO₄).

In more specific embodiments, Li may be present in the cathode active materials an amount between about 1 wt % and about 99 wt %, about 1 wt % and about 95 wt %, about 1 wt % and about 90 wt %, about 1 wt % and about 85 wt %, about 1 wt % and about 80 wt %, about 1 wt % and about 50 wt %, about 10 wt % and about 99 wt %, about 10 wt % and about 95 wt %, about 10 wt % and about 90 wt %, about 10 wt % and about 85 wt %, about 10 wt % and about 80 wt %, about 10 wt % and about 50 wt %, about 25 wt % and about 99 wt %, about 25 wt % and about 95 wt %, about 25 wt % and about 90 wt %, about 25 wt % and about 85 wt %, about 25 wt % and about 80 wt %, about 25 wt % and about 50 wt %, about 50 wt % and about 99 wt %, about 50 wt % and about 95 wt %, about 50 wt % and about 90 wt %, about 50 wt % and about 85 wt %, about 50 wt % and about 80 wt %, about 1 wt % and about 20 wt %, about 5 wt % and about 20 wt %, about 10 wt % and about 50 wt %, or about 15 wt % and about 20 wt %. In such embodiments, the anode may not contain lithium ion or lithium metal. In other embodiments, the anode may contain additional sources of Li to supplement the Li not contained in the unlithiated cathode.

In other embodiments the cathode may contain at least two distinct cathode active materials or mixtures of cathode active materials in separate cathode layers to form of a bipolar cathode.

Cathode active materials that contain manganese may suffer decreases in performance or failure due to dissolution of manganese through the cell, particularly during use. Non-lithiated metal phosphate in cathode active materials and cathode of the present disclosure may act as a stabilizing and balancing factor that decreases or prevents manganese dissolution during use of a cell.

In some embodiments, one or more, or all of the cathode active materials may not contain cobalt. In contrast to toxic cobalt, iron, manganese, and nickel are generally non-toxic and, even if released by damage to a battery, are very unlikely to be taken up by the body in harmful amounts. In addition, these cathode active materials may help prevent thermal runaway and resulting battery or cell damage and fires. However, embodiments in which one or more, or all of the cathode active materials do contain cobalt are also suitable for use in a cathode as disclosed herein.

In some embodiments, the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Mn, and Co, such as between 80 wt % and about 99 wt %, between 80 wt % and about 95 wt %, between 80 wt % and about 90 wt %, or between 80 wt % and about 85 wt %.

In some embodiments in which the NMC has the general chemical formula LiNi_{1-x-y}MnₓCo_{y}O₂, wherein x is such that Mn is present in an amount of up to 30 wt % of the total weight of the NMC. In more specific embodiments, Mn may be present in an amount of between about 1 wt % and 30 wt %, about 5 wt % % and 30 wt %, about 10 wt % and 30 wt % %, or about 20 wt % and 30 wt %.

In a more specific embodiment, the NMC has the chemical formula LiNi_{0.8}CO_{0.1}Mn_{0.1}O₂. In some embodiments, the NCA has the general chemical formula LiNi_{1-x-y}CoₓAl_{y}O₂, wherein 1−x−y, x, and y are each greater than 0. In specific embodiments, 0<x≤0.2, more specifically 0.01≤x≤0.2, 0.1≤x≤0.2 and 0<y≤0.2 more specifically 0.01≤y≤0.2, 0.1≤y≤0.2. In more specific embodiments, 0.6≤(1−x−y)≤0.99, more specifically, 0.6≤(1−x−y)≤0.9, 0.6≤(1−x−y)≤0.8, 0.6≤(1−x−y)≤0.7.

In some embodiments, the NCA has the general chemical formula LiNi_{1-x-y}CoₓAl_{y}O₂, and 1−x−y is such that Ni is present in an amount of at least 50 wt % of the total weight of Ni, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Co, and Al, such as between 80 wt % and about 99 wt %, between 80 wt % and about 95 wt %, between 80 wt % and about 90 wt %, or between 80 wt % and about 85 wt %.

In some embodiments, the NMCA has the general chemical formula LiNi_{1-x-y-z}MnₓCo_{y}Al_{z}O₂, wherein 1−x−y−z, x, y, and z are each greater than 0. In specific embodiments, 0<x≤0.2, more specifically 0.01≤x≤0.2, 0.1≤x≤0.2, 0<y≤0.2 more specifically 0.01≤y≤0.2, 0.1≤y≤0.2, and 0<z≤0.2, more specifically 0.01≤z≤0.2, 0.1≤z≤0.2. In more specific embodiments, 0.4≤(1−x−y−z)≤0.99, more specifically, 0.4≤(1−x−y)≤0.9, 0.4≤(1−x−y)≤0.8, 0.4≤(1−x−y)≤0.7.

In some embodiments, the NMCA has the general chemical formula LiNi_{1-x-y-z}MnₓCo_{y}Al_{z}O₂, wherein 1−x−y−z is such that Ni is present in an amount of at least 50 wt % of the total weight of Ni, Mn, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y−z is such that Ni is present in an amount of at least 80 wt % of the total weight of Ni, Mn, Co, and Al, such as between 80 wt % and about 99 wt %, between 80 wt % and about 95 wt %, between 80 wt % and about 90 wt %, or between 80 wt % and about 85 wt %.

In some embodiments, the LFP has the general chemical formula LiFePO₄.

Lithium metal phosphate cathode active materials 50a may include LMFP. In some embodiments, these materials have the general chemical formula LiMnₓFe₁₋ₓPO₄, wherein 0.01≤x≤0.95.

In more specific embodiments, 0.01≤x≤0.5, 0.01≤x≤0.4, 0.01≤x≤0.3, 0.01≤x≤0.25, 0.01≤x≤0.2, 0.01≤x≤0.15, 0.01≤x≤0.10, 0.01≤x≤0.05, 0.05≤x≤0.95, 0.05≤x≤0.5, 0.05≤x≤0.4, 0.05≤x≤0.3, 0.05≤x≤0.25, 0.05≤x≤0.2, 0.05≤x≤0.15, 0.05≤x≤0.1, 0.1≤x≤0.95, 0.1≤x≤0.5, 0.1≤x≤0.4, 0.1≤x≤0.3, 0.1≤x≤0.25, 0.1≤x≤0.2, 0.1≤x≤0.15, 0.15≤x≤0.95, 0.15≤x≤0.5, 0.15≤x≤0.4, 0.15≤x≤0.3, 0.15≤x≤0.25, 0.15≤x≤0.2, 0.2≤x≤0.95, 0.2≤x≤0.5, 0.2≤x≤0.4, 0.2≤x≤0.3, or 0.2≤x≤0.25. In a more specific embodiment, the materials have the chemical formula LiMn_{0.2}Fe_{0.8}PO₄.

In other more specific embodiments, 0.5≤x≤0.95, 0.5≤x≤0.8, 0.5≤x≤0.7, 0.5≤x≤0.6, 0.6≤x≤0.95, 0.6≤x≤0.8, 0.6≤x≤0.7, 0.7≤x≤0.95, 0.7≤x≤0.8, or 0.8≤x≤0.95. In a more specific embodiment, the materials have the chemical formula LiMn_{0.5}Fe_{0.5}PO₄, and LiMn_{0.8}Fe_{0.2}PO₄.

Lithium metal phosphate cathode active materials 50a may include LMNFP. In some embodiments, these materials have the general chemical formula LiMnₓNi_{y}Fe_{1-(x+y)}PO₄, in which 0<x<1, 0<y<1 and x+y<1. In some specific embodiments:
a) 0<x≤0.05, more particularly 0.005≤x≤0.05, 0.005≤x≤0.04, 0.005≤x≤0.03, 0.005≤x≤0.02, 0.01≤x≤0.05, 0.01≤x≤0.04, 0.01≤x≤0.03, 0.01≤x≤0.02, 0.02≤x≤0.05, 0.02≤x≤0.04, 0.02≤x≤0.03, 0.03≤x≤0.05, 03, 0.03≤x≤0.04, or 0.04≤x≤0.05;
b) 0<y≤0.3, more particularly 0.005≤y≤0.3, 0.005≤y≤0.25, 0.005≤y≤0.2, 0.005≤y≤0.16, 0.005≤y≤0.15, 0.005≤y≤0.1, 0.005≤y≤0.05, 0.005≤y≤0.01, 0.01≤y≤0.3, 0.01≤y≤0.25, 0.01≤y≤0.2, 0.01≤y≤0.16, 0.01≤y≤0.15, 0.01≤y≤0.1, 0.01≤y≤0.05, 0.05≤y≤0.3, 0.05≤y≤0.25, 0.05≤y≤0.2, 0.05≤y≤0.16, 0.05≤y≤0.15, 0.05≤y≤0.1, 0.1≤y≤0.3, 0.1≤y≤0.25, 0.1≤y≤0.2, 0.1≤y≤0.16, 0.1≤y≤0.15, 0.15≤y≤0.3, 0.15≤y≤0.25, 0.15≤y≤0.2, 0.15≤y≤0.16, 0.16≤y≤0.3, 0.16≤y≤0.25, 0.16≤y≤0.2, 0.2≤y≤0.3, 0.2≤y≤0.25, or 0.25≤y≤0.3; or
c) 0<x+y≤0.3, more particularly 0.005≤x+y≤0.3, 0.005≤x+y≤0.25, 0.005≤x+y≤0.2, 0.005≤x+y≤0.15, 0.005≤x+y≤0.1, 0.005≤x+y≤0.05, 0.005≤x+y≤0.01, 0.01≤x+y≤0.3, 0.01≤x+y≤0.25, 0.01≤x+y≤0.2, 0.01≤x+y≤0.15, 0.01≤x+y≤0.1, 0.01≤x+y≤0.05, 0.05≤x+y≤0.3, 0.05≤x+y≤0.25, 0.05≤x+y≤0.2, 0.05≤x+y≤0.15, 0.05≤x+y≤0.1, 0.1≤x+y≤0.3, 0.1≤x+y≤0.25, 0.1≤x+y≤0.2, 0.1≤x+y≤0.15, 0.15≤x+y≤0.3, 0.15≤x+y≤0.25, 0.15≤x+y≤0.2, 0.2≤x+y≤0.3, 0.2≤x+y≤0.25, or 0.25≤x+y≤0.3.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In a more specific embodiment, the materials have the chemical formula LiMn_{0.04}Ni_{0.16}Fe_{0.8}PO₄.

In some embodiments, LFCP has the general chemical formula LiFe1−xCoxPO4, in which 0<x<1. In some specific embodiments, x≥0.05, x≥0.1, x≥0.2, x≥0.3, x≥0.4, x≥0.5, x≥0.6, x≥0.7, x≥0.8, x≥0.9, or x≥0.95.

In some embodiments, LFMCP has the general chemical formula LiFe1−(x+y)MnxCoyPO4, in which 0<x<1, 0<y<1 and x+y<1. In some specific embodiments, a) 0<x≤0.5, more particularly 0.05≤x≤0.50, 0.05≤x≤0.25, 0.05≤x≤0.2, 0.05≤x≤0.15, 0.05≤x≤0.1, 0.1≤x≤0.5, 0.1≤x≤0.25, 0.1≤x≤0.2, or 0.1≤x≤0.15; b) 0<y≤0.95, more particularly 0.05≤y≤0.95, 0.05≤y≤0.9, 0.05≤y≤0.75, 0.05≤y≤0.5, 0.05≤y≤0.25, 0.05≤y≤0.1, 0.1≤y≤0.95, 0.1≤y≤0.9, 0.1≤y≤0.75, 0.1≤y≤0.5, or 0.1≤y≤0.25; or c) 0<x+y≤0.95, more particularly 0.05≤x+y≤0.95, 0.05≤x+y≤0.75, 0.05≤x+y≤0.5, 0.05≤x+y≤0.25, 0.05≤x+y≤0.1, 0.1≤x+y≤0.95, 0.1≤x+y≤0.9, 0.1≤x+y≤0.75, 0.1≤x+y≤0.5, or 0.1≤x+y≤0.25.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In a more specific embodiment, the materials have the chemical formula LiMn0.04Ni0.16Fe0.8PO4.

In some embodiments, lithium cobalt oxide, lithium nickel aluminum oxide, NMC, NCA, NMCA, LFP, LMFP, LMNFP, LFCP, or LFMCP may include additional elements included in their crystal structures. These additional elements may affect electrical conductivity and/or lithium ion intercalation of the cathode active material. Additional elements may have or be capable of existing in a charge state equal to that of the element replaced in the crystal structure. For example, iron may be replaced with another element that may exist in a 2+ or 3+ charge state. The additional element may be a transition metal also able to move from one charge to another during an electrochemical reaction, or if may be a fixed valence material, such as a fixed-valence 2+ metal in place of iron. Phosphorus may also be replaced, where present with sulfur or silicon. The amount of transition metal replaced by another metal may be 10%, 5%, 2%, 1%, 0.5%, or 0.1% or less, or in a range of 0.1% to 10%, 0.1% to 5%, 0.1% to 2%, 0.1% to 1%, 0.1% to 0.5%, 0.5% to 5%, 0.5% to 2%, 0.5% to 1%, 1% to 5%, 1% to 2%, or 2% to 5%.

In some embodiments, the lithium cobalt oxide, lithium nickel aluminum oxide, NMC, NCA, NMCA, LFP, LMFP, LMNFP, LFCP, or LFMCP. may be partially unlithiated when the cell 10 is uncycled. In specific embodiments, lithium cobalt oxide, lithium nickel aluminum oxide, NMC, NCA, NMCA, LFP, LMFP, LMNFP, LFCP, or LFMCP may and contain lithium in an amount up to 99%, up to 95%, up to 90%, up to 85%, up to 80%, up to 50%, or up to 20 wt % of the total weight of the lithium cobalt oxide, lithium nickel aluminum oxide, NMC, NCA, NMCA, LFP, LMFP, LMNFP, LFCP, or LFMCP. In more specific embodiments, Li may be present in the cathode active materials an amount between about 1 wt % and about 99 wt %, about 1 wt % and about 95 wt %, about 1 wt % and about 90 wt %, about 1 wt % and about 85 wt %, about 1 wt % and about 80 wt %, about 1 wt % and about 50 wt %, about 10 wt % and about 99 wt %, about 10 wt % and about 95 wt %, about 10 wt % and about 90 wt %, about 10 wt % and about 85 wt %, about 10 wt % and about 80 wt %, about 10 wt % and about 50 wt %, about 25 wt % and about 99 wt %, about 25 wt % and about 95 wt %, about 25 wt % and about 90 wt %, about 25 wt % and about 85 wt %, about 25 wt % and about 80 wt %, about 25 wt % and about 50 wt %, about 50 wt % and about 99 wt %, about 50 wt % and about 95 wt %, about 50 wt % and about 90 wt %, about 50 wt % and about 85 wt %, about 50 wt % and about 80 wt %, about 1 wt % and about 20 wt %, about 5 wt % and about 20 wt %, about 10 wt % and about 50 wt %, or about 15 wt % and about 20 wt %. In such embodiments, the anode may not contain lithium ion or lithium metal. This results in a cell in which all of the lithium cobalt oxide, lithium nickel aluminum oxide, NMC, NCA, NMCA, LFP, LMFP, LMNFP, LFCP, or LFMCP is normally not fully lithiated, even when the cell is fully discharged.

The lithium compound may include a halide, such as F, or the lithium compound material may be doped with an inorganic halide composition, such as an inorganic fluoride composition, such as a metal fluoride.

The cathode active material 50 may be coated, for example with an inorganic halide composition, such as an inorganic fluoride composition, such as a metal fluoride, or a conductivity enhancer, such as carbon.

In more specific embodiments, the metal fluorides may be LiF, ZnF₂, AlF₃, and any combinations thereof. AlF₃ may be particularly useful due to its reasonable cost and low negative environmental impact.

In still other embodiments, the cathode active-material containing layer 30 may at least 90 wt % cathode active material 50 which, for purposes of this measurement, includes any coating or dopant. More specifically, the cathode layer 30 may include between about 90 wt % and about 99 wt %, about 90 wt % and about 98 wt %, about 90 wt % and about 97 wt %, about 90 wt % and about 96 wt %, or about 90 wt % and about 95 wt % cathode active material 50.

Cathode active-material containing layer 30 may contain additional materials, such as polymer binders and conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the anode may include a conductivity enhancer, polymer binder, or other additive.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In some embodiments, the cathode active-material containing layer 30 may include 5 wt % or less conductivity enhancer. More specifically, the cathode active-material containing layer 30 may include between about 1 wt % and about 5 wt %, between about 2 wt % and about 5 wt %, about 1 wt % and about 4 wt %, about 2 wt % and about 4 wt %, or about 3 wt % and about 4 wt % conductivity enhancer.

Suitable polymer binders include binders that adhere the cathode active material to other components of the cathode 20, such as the cathode current collector 40. In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber/carboxyl methyl-cellulose (SBR/CMC), sodium alginate, or sodium acrylate, and any mixtures and copolymers thereof.

In some embodiments, the cathode active-material containing layer 30 may include 6 wt % or less polymer binder. More specifically, the cathode active-material containing layer 30 may include between about 1 wt % and about 6 wt %, between about 2 wt % and about 6 wt %, about 1 wt % and about 5 wt %, about 2 wt % and about 5 wt %, or about 3 wt % and about 5 wt % polymer binder.

Cathode 20 also includes cathode current collector 40, which may be any suitable electrically conductive material, such as a metal foil, a metal grid, a metal screen, metal foam, or expanded metal (which is a metal grid or metal screen that has a thickness sufficient to allow a substantial amount of cathode active material to collect within it) or at least one graphene layer, typically a plurality of graphene layers. In some embodiments, cathode current collector 40 may include Al, Ni, Ti, C, stainless steel, or any combinations thereof. In a specific embodiment, the cathode current collector 40 is aluminum, more specifically aluminum foil. In some embodiments, if the current collector includes or is a metal, it may further include a conductive and corrosion-resistant coating, such as TiN.

In some embodiments, not depicted, cathode active-material containing layers 30 may be formed on both sides of the cathode current collector.

### Electrolyte

The electrolyte 100 may be a liquid, gel, or solid electrolyte.

The electrolyte 100 may include any electrolyte that does not substantially degrade at the cycling voltages of electrochemical cell 10.

Electrolyte 100 may include an ionic liquid, an organic liquid, or a combination thereof. If the ionic liquid or organic liquid does not supply lithium ion, then electrolyte 100 may include a lithium salt. In more specific embodiments, electrolyte 100 may also include a flame retardant.

In some embodiments, electrolyte 100 may be any organic material, such as an organic liquid, an ionic liquid, or any combinations thereof. If the organic liquid does not supply lithium ion, then electrolyte 100 also includes a lithium salt. In more specific embodiments, electrolyte 100 may also include an additive, such as an additive that reduces or prevents gas creating in cell 10, an additive the reduces or prevents manganese dissolution, or an additive the forms a passivation layer, particularly on the anode, or any combinations of such additives.

In some embodiments, the organic liquid may include:
an ether, such as ethylene glycol dimethyl ether (1,2-dimethoxyethane), ethylene glycol diethyl ether, tetrahydrofuran, 2-methyltetrahydrofuran, 2,6-dimethyltetrahydrofuran, tetrahydropyran, a crown ether, triethylene glycol dimethyl ether, tetraethylene glycol dimethyl ether, 1,4-dioxane, or 1,3-dioxolane;
a carbonic acid ester, such as dimethyl carbonate, methyl ethyl carbonate, diethyl carbonate, diphenyl carbonate, or methyl phenyl carbonate;
a cyclic carbonate ester, such as ethylene carbonate, propylene carbonate, ethylene 2,3-dimethyl carbonate, butylene carbonate, vinylene carbonate, or ethylene 2-vinyl carbonate;
a fluorinated ethylene carbonate;
an aliphatic carboxylic acid ester, such as methyl formate, methyl acetate, methyl propionate, ethyl acetate, propyl acetate, butyl acetate, or amyl acetate;
an aromatic carboxylic acid ester, such as methyl benzoate or ethyl benzoate;
a carboxylic acid ester, such as γ-butyrolactone, γ-valerolactone, or 5-valerolactone;
a phosphoric acid ester, such as trimethyl phosphate, ethyl dimethyl phosphate, diethyl methyl phosphate, or triethyl phosphate;
a nitrile, such as acetonitrile, propionitrile, methoxypropionitrile, glutaronitrile, adiponitrile, 2-methylglutaronitrile, valeronitrile, butyronitrile, or isobutyronitrile;
an amide, such as N-methylformamide, N-ethylformamide, N,N-dimethylformamide, N,N-dimethylacetamide, N-methylpyrrolidinone, N-methylpyrrolidone, or N-vinylpyrrolidone;
a sulfur-based compound, such as dimethyl sultone, methyl ethyl sultone, diethyl sultone, sulfolane, 3-methylsulfolane, or 2,4-dimethylsulfolane;
an alcohol, such as ethylene glycol, propylene glycol, ethylene glycol monomethyl ether, or ethylene glycol monoethyl ether;
a sulfoxide, such as dimethyl sulfoxide, methyl ethyl sulfoxide, or diethyl sulfoxide;
an aromatic nitrile, such as benzonitrile or tolunitrile;
a nitromethane;
1,3-dimethyl-2-imidazolidinone;
1,3-dimethyl-3,4,5,6-tetrahydro-2(1,H)-pyrimidinone;
3-methyl-2-oxazolidinone; or any combinations thereof.

In some more specific embodiments, the organic liquid includes a carbonic acid ester, an aliphatic carboxylic acid ester, a carboxylic acid ester, an ether, or any combination thereof.

In some embodiments, the additive that reduces or prevents gas creation may include vinylene carbonate (VC), poly(ethyl methacrylate) (PEMA), polyethyl phenylethylmalonamide (PEMAO), Li₂Co₃, and any combinations thereof.

In some embodiments, the additive that forms a passivation layer may include VC, as fluoroethylene carbonate (FEC), Poly(3,4-ethylenedioxythiophene) (PEDOT), poly(styrenesulfonate) (PSS), polyvinyl acrylate (PVA), polyethylene glycol (PEG), polyethylene oxide (PEO), poly(methyl methacrylate) (PMMA) and any combinations thereof.

In some embodiments, the additive reduces or prevents Mn dissolution may include VC, FEC, or any combinations thereof.

In some embodiments, the electrolyte 100 may include another additive, such as an anhydride, prop-1-ene-1,3-sultone (PES), or a combination thereof.

Electrolyte 100 may include any combinations of any or all additives.

In more specific embodiments, the total weight of additives may be about 5 wt % or less of the total electrolyte weight. In still more specific embodiments, the total weight of additive may be between about 1 wt % and about 5 wt %.

In some embodiments, the lithium salt includes LiPF₆, LiFSi, LiTFSI, KFSI, KTFSI, LiBF₄, CH₃COOLi, CH₃SO₃Li, CF₃SO₃Li, CF₃COOLi, Li₂B₁₂F₁₂, LiBC₄O₈;
salts with the general formula R₁—SO₂—NLi—SO₂—R₂, where R₁ and R₂ independently are F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃;
salts with the general formula

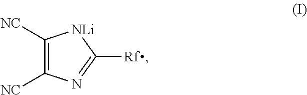

wherein Rf is F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃; or any combinations thereof.

In more specific embodiments, the electrolyte 100 may include between about 0.5 M and about 2 M lithium salt.

In other embodiments, electrolyte 100 is a chemical composition or mixture of chemical compositions that do not contain lithium hexafluorophosphate as an electrolyte lithium salt. The presence of lithium hexafluorophosphate in the electrolyte composition of lithium batteries has been shown to promote the production of hydrofluoric acid and hydrogen fluoride gas, both of which can lead to increased degradation of the cell or battery. An advantage of the electrolyte compositions disclosed herein is that they avoid or lower the production hydrofluoric acid and hydrogen fluoride gas in the cell or battery, as compared to otherwise similar electrolytes containing lithium hexafluorophosphate. This increases battery safety and may increase cycle life.

In some embodiments, the ionic liquid may be any ionic liquid that is a liquid at 20° ° C. In more specific embodiments, the ionic liquid may include bis(fluorosulfonyl)imide (FSI), bis(trifluoromethane)sulfonamide (TFSI), imidazolium, a phosphonium phosphate, a phosphonium thiophosphate, or any combinations thereof.

In more specific embodiments, electrolyte 100 may also include a flame retardant.

In some embodiments, the flame retardant includes a perfluorocarbon, an alkane, an ether, a ketone, an amine substituted with one or more alkyl groups, or any combinations thereof. In more specific embodiments, the flame retardant may be at least 60% fluorinated (i.e. 60% of the individual flame retardant molecules are fluoridated).

In some embodiments, the flame retardant includes a ketone having the general formula R′(C═O)R″, wherein R′ is a perfluoroalkyl group and R″ is a perfluoroalkyl group or an alkyl group. More specifically, the ketone is a perfluoroketone, such as dodecafluoro-2-methylpentan-3-one.

In other embodiments, the flame retardant includes an ether having the general formula R′OR″, wherein R′ is a perfluoroalkyl group and R″ is a perfluoroalkyl group or an alkyl group. In more specific embodiments, the ether is a segregated hydrofluoroether, such as methoxy-heptafluoropropane, methoxy-nonafluorobutane, ethoxy-nonafluorobutane, perfluorohexylmethylether, or 2-trifluoromethyl-3-ethoxydodecofluorohexane.

In some embodiments, the flame retardant does not contain ethers or, more specifically, fully or partially halogenated ethers.

In some embodiments, the flame retardant includes an amine substituted with one or more perfluoroalkyl groups, such as perfluorotripentylamine, perfluorotributylamine, perfluorotripropylamine, or perfluoro-n-dibutylmethylamine.

In some embodiments, flame retardant can include a perfluoroalkane such as perfluoropentane, perfluorohexane, perfluoroheptane, perfluoroctane, or perfluoro-1,3-dimethylcyclohexane.

In some embodiments, the flame retardant includes a phosphazene, such as a cyclic phosphazene, more particularly cyclotriphosphazene. In more specific embodiments, the cyclic phosphazene is fully or partially halogenated. In even more specific embodiments, the cyclic phosphazene is fully or partially fluorinated. In still other embodiments, additionally or alternately, the cyclic phosphazene has one or more substituents selected from linear or cyclic alkyl groups, alkoxy groups, cycloalkoxy groups, and aryloxy groups. In more specific embodiments, the substituents are unhaloghenated, fully halogenated or partially halogenated. In other more specific embodiments, the cyclic phosphazene is fully substituted with halogens and substituents such as linear or cyclic alkyl groups, alkoxy groups, cycloalkoxy groups, and aryloxy groups.

### Electrode Stacks

The present disclosure relates to electrodes arranged in stacks, such as stacks in which anode/separator/cathode/anode . . . alternate. In some embodiments, the electrode stacks having a slotted structure created by an accordion-shaped separator, which may be referred to as “slot electrodes” or “slot electrode stacks.” When the separator is folded into an accordion shape, it creates slots on alternating sides of the separator into with cathodes and anodes fit so that there is separator on both sides of each cathode or each anode. A plurality of stopping points, each located at an end of a slot, are also formed by the folds of the separator. These stopping points can help make assembly of the electrode stack easier or prevent electrodes from shifting position too far during use.

In some embodiments, an electrode stack may include alternating layers of cathode/separator/anode. Such a stack might exhibit edge effects, which create areas where electrochemical reactions cannot take place, decreasing the energy density of the cell or battery containing the electrode stack and also possibly resulting in dendrite formation. To avoid this, the ends of the stack may be cut off, for example, with a laser, to achieve more precise boundaries. In some embodiments, scarring resulting from such cutting is performed may be repaired placing metal on the ends of electrode the electrode stack at boundaries after they are cut. In some embodiments, aluminum metal may be placed at one cut edge and copper may be placed at the other cut edge, corresponding to positive and negative ends of the stack.

### Batteries

Batteries of the present disclosure include any high capacity anode or electrochemical cell disclosed herein. Batteries of the present disclosure may exhibit any of the electrochemical properties attributed to high capacity anodes, when located in an electrochemical cell, or electrochemical cells disclosed herein.

In some embodiments, the battery may be a simple electrochemical cell in a casing. In other embodiments, it may include a more complex electrochemical cell or plurality of cells. For example, in some embodiments, the electrodes may be separated by separators, then rolled within a casing as illustrated in FIG. 2 or stacked within a casing (not shown).

In some embodiments, the casing of a battery may be a polymeric film, a metallic foil, a metal can, or any combination thereof. In some embodiments, the casing may include a vent.

In some embodiments, the battery may be thus formed can be a coin or button cell battery, a cylindrical battery, or a prismatic cell battery or pouch cell battery.

In some embodiments, a battery as described herein includes active materials that provide a high degree of safety. Commercial lithium ion batteries have suffered from safety concerns due to occasions of batteries catching fire. In contrast with commercial batteries having relatively high energy capacity, the batteries described herein are based on active materials that do not share the corresponding instabilities of the commercial batteries and thus exhibit thermal run away to a significant lower extent or not at all. In some embodiments, if the batteries described herein are heated, they do not spontaneously react to catch fire. Relatively high energy commercial lithium ion batteries exhibit thermal runaway in which the heated cells undergo reaction and catch fire. Thus, the batteries described herein may provide improved energy capacity as well as providing increased safety during use.

Rechargeable batteries have a range of uses, such as mobile communication devices, such as phones, mobile entertainment devices, portable computers, combinations of these devices that are finding wide use, as well as transportation devices, such as automobiles and forklifts. Batteries as described herein may, therefore, be used in a variety of commercial forms.

FIG. 2 illustrates a cylindrical battery 200, according to some embodiments of the present disclosure, that operates using the principles of electrochemical cell 10 depicted in FIG. 1. Battery 200 includes a jelly roll of alternating layers of cathode 20, which has cathode active material 50 on both sides of cathode current collector 40 and anode 60, which also has anode active material 90 on both sides of anode current collector 80. A layer of separator 110 is between each layer of cathode 20 and anode 60. Battery 200 also includes a casing 250 formed from side 210, top 220, and bottom 230. The electrolyte (not shown) is contained by the casing 250.

In some embodiments, the casing 250 has a length L and an average diameter D. In some embodiments, the length L may be between about 2 cm and about 10 cm, about 3 cm and about 10 cm, about 4 cm and about 10 cm, about 4.4 cm and about 10 cm, about 4.45 cm and about 10 cm, about 5 cm and about 10 cm, about 5.05 cm and about 10 cm, about 6.5 cm and about 10 cm, about 2 cm and about 6.5 cm, about 4 cm and about 5.5 cm, or about 4.4 cm and about 5.05 cm, and the diameter D may be between about 1 cm and about 3.5 cm, about 1.05 cm and about 3.5 cm, about 1.45 cm and about 3.5 cm, about 1.5 cm and about 3.5 cm, about 1 cm and about 3 cm, or about 1 cm and about 2 cm, in any combinations of these ranges of lengths and diameters.

In other embodiments, the casing 250 has a length L and an average diameter D. In some embodiments, the length L may be between about 1 cm and about 10 cm, about 5 cm and about 10 cm, about 5 cm and about 8 cm, about 5 cm and about 7 cm, 5 cm and about 20 cm, about 5 cm and about 15 cm, about 5 cm and about 10 cm, 5 cm and about 1 m, about 10 cm and about 1 m, about 20 cm and about 1 m, or about 50 cm and about 1 m, and the diameter D may be between about 1 cm and about 10 cm, about 2 cm and about 6 cm, about 2 cm and about 5 cm, about 2 cm and about 10 cm, or about 5 cm and about 10 cm, in any combinations of these ranges of lengths and diameters.

FIG. 3 illustrates a prismatic cell battery 300, according to some embodiments of the present disclosure, that operates using the principles of electrochemical cell 10 depicted in FIG. 1. The battery includes a cathode 20, which includes cathode current collector 40, an anode 60, which includes an anode current collector 80, and a separator 110 between the cathode 20 and the anode 60. Although FIG. 3 illustrates only one cathode 20 and anode 60 for simplicity, the cathodes and anodes are typically stacked in an alternating fashion with separators between them. The cathodes and anodes also typically contain active material on both sides of the respective current collectors.

Prismatic cell battery 300 further includes a casing 310, which is illustrated as a metal pouch.

Prismatic cell battery 300 further includes a casing 310, which is illustrated as a metal pouch. Prismatic cell battery 300 may have a length, L which may be between about 10 cm and about 1 m, between about 10 cm and about 500 cm, between about 10 cm and between about 100 cm, between about 25 cm and about 1 m, between about 25 cm and about 500 cm, between about 25 cm and about 100 cm, between about 50 cm and about 1 m, between about 50 cm and about 500 cm, between about 50 cm and about 100 cm, between about 100 cm and 1 m, or between about 100 cm and about 500 cm, a width, W, which may be between about 2 cm and about 20 cm, about 2 cm and about 10 cm, about 2 cm and about 5 cm, about 5 cm and about 20 cm, or about 5 cm and about 10 cm, and a height, H, between about 2 cm and about 50 cm, about 2 cm and about 20 cm, about 2 cm and about 10 cm, about 5 cm and about 50 cm, about 5 cm and about 20 cm, about 5 cm and about 10 cm, about 10 cm and about 50 cm, or about 10 cm and about 20 cm, in any combinations of these ranges of lengths, width, and heights.

FIG. 4 illustrates a battery module or pack 400, such as an electric vehicle battery, which includes a stack 420 of prismatic cell batteries 300, such as those illustrated in FIG. 3 or similar to those of FIG. 3, but with stacked cathodes and anodes. Stack 420 is enclosed in a housing 410. Anode current collectors 80 and cathode current collectors 40 in each of batteries 300 are electrically connected to negative connector 430 and positive connector 440, respectively. Electrons 150 may flow between negative connector 430 and positive connector 440 to power vehicle 450, or (not shown), when connected to an energy source, such as and AC outlet, to charge battery 400.

The battery 400 may also include safety equipment 450, control equipment 460, or both. Safety equipment 450 and control equipment 460 may located inside housing 410, or all or part of safety equipment 450 or control equipment 460 may be located outside housing 410. In some embodiments safety equipment 450 may include equipment that minimizes damage should one of batteries 300 fail or potentially or actually cause damage. For example, safety equipment 450 may include a fan or a fire-suppression material and delivery system. In some embodiments control equipment 460 may include a processor and an associated memory, in which the processor is able to execute a program stored in the associated memory to control one or more functions of the battery 400. The processor may also receive information regarding battery 400, vehicle 470, or batteries 300 and use such information to control one or more functions of battery 400.

Batteries of the present disclosure may also be suitable for use with small electronics.

### Methods of Making Electrodes, Cells, and Batteries

As illustrated in FIG. 8A, anode 60 having a structure as set forth in FIG. 5G or similar counterpart anodes 60 have the general structures of FIGS. 6A and 7A may be formed in a lithiation chamber 500a, that contains an inert atmosphere 520 as well as vessel 510 containing lithium salt solution 530, such as 1.7 M N-butyllithium in hexane. When an unlithiated anode 60 is placed in the lithium salt solution 530, the anode active materials 90 are coated with lithium salt.

As illustrated in FIG. 8B, anode 60 having a structure as set forth in FIG. 5A-5E, 6A-6E or 7A-7E may be formed in a lithiation chamber 500b, that contains an inert atmosphere 520 as well as vessel 510 containing molten lithium 540 (lithium metal heated to greater than 180° C.). When unlithiated anode 60 is placed in the molten lithium 540, lithium is deposited on the anode active materials 90.

The various embodiments described above can be combined to provide further embodiments. Aspects of the embodiments can be modified in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A high capacity lithium ion anode comprising:
an anode active material-containing layer having an electrolyte-facing side and a current collector-facing side, the anode active material-containing layer comprising:
a graphite anode active material comprising graphite particles and/or a graphite layer;
a silicon or silicon compound active material comprising silicon or silicon compound particles and/or a silicon or silicon compound layer; and
a lithium reservoir; and
an anode current collector.

2-3. (canceled)

4. The high capacity lithium ion anode of claim 1, wherein the anode active material further comprises at least one of the following in addition to or in place of graphite or silicon: the anode active material may include a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof.

5. The high capacity lithium ion anode of claim 1, wherein the lithium reservoir comprises lithium metal particles.

6. The high capacity lithium ion anode of claim 1, wherein the lithium reservoir comprise a lithium metal sheet.

7. The high capacity lithium ion anode of claim 1, wherein the lithium reservoir comprise a lithium salt.

8. The high capacity lithium ion anode of claim 7, wherein the lithium salt is freely dispersed in the anode active material-containing layer.

9. The high capacity lithium ion anode of claim 7, wherein the lithium salt is coated on the graphite anode active material and the silicon or silicon composition active material.

10. The high capacity lithium ion anode of claim 7, wherein the lithium salt comprises lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl)imidazole (LiTDI), lithium hexafluorophosphate (LiPF₆), lithium iodide (LiI), or any mixtures or combinations thereof.

11. The high capacity lithium ion anode of claim 1 wherein the silicon compound comprises SiOₓ in which x≤2.

12. The high capacity lithium ion anode of claim 1, wherein the graphite anode active material comprises natural graphite, synthetic graphite, or a combination thereof.

13. The high capacity lithium ion anode of claim 1, wherein the anode further comprises a lithium metal phosphate.

14. A high capacity lithium ion cell comprising:
a high capacity anode of claim 1;
an uncycled cathode comprising a cathode active material comprising a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof,
wherein:
the LMFP cathode active material has the general chemical formula LiMnₓFe₁₋ₓPO₄, wherein 0.01≤x≤0.95;
the LMNFP cathode active material has the general chemical formula LiMnₓNi_{y}Fe_{1-(x+y)}PO₄, wherein 0<x<1, 0<y<1 and x+y<1 and wherein the ratio of x:y is in a range between 5:1 and 1:5;
the LFCP cathode active material has the general chemical formula LiFe₁₋ₓCoₓPO₄, in which 0<x<1;
the LFMCP cathode active material has the general chemical formula LiFe_{1-(x+y)}MnₓCo_{y}PO₄, wherein 0<x<1, 0<y<1 and x+y<1 and wherein wherein the ratio of x:y is in a range between 5:1 and 1:5; and
wherein at least one of the LMFP, LMNFP, LFCP, LFMCP, or LFP is coated with conductive carbon; and
an electrolyte.

15. A battery comprising:
at least one lithium ion cell of claim 14; and
a casing.

16. (canceled)

17. A vehicle battery comprising:
at least one battery according to claim 15; a positive connector;
a negative connector; and
a housing.

18. (canceled)

19. The lithium ion cell of claim 14, wherein the cathode active material comprises:
i) a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof; and
ii) a manganese iron phosphate (MFP) cathode active material, a manganese nickel iron phosphate (MNFP) cathode active material, an iron phosphate (FP) cathode active material, an iron cobalt phosphate (FCP) cathode active material, an iron manganese cobalt phosphate (FMCP) cathode active material, or any combinations thereof,
wherein:
the MFP cathode active material has the general chemical formula MnₓFe₁₋ₓPO₄, wherein 0.01≤x≤0.95;
the MNFP cathode active material has the general chemical formula MnₓNi_{y}Fe_{1-(x+y)}PO₄, wherein 0<x<1, 0<y<1 and x+y<1, and wherein the ratio of x:y is in a range between 5:1 and 1:5;
the FCP cathode active material has the general chemical formula Fe₁₋ₓCoₓPO₄, in which 0<x<1; and
the FMCP cathode active material has the general chemical formula Fe_{1-(x+y)}MnₓCo_{y}PO₄, wherein 0<x<1, 0<y<1 and x+y<1 and wherein the ratio of x:y is in a range between 5:1 and 1:5; and
wherein at least one of the LMFP, LMNFP, LFCP, LFMCP, LFP, MFP, MNFP, FCP, FMCP, or LP is coated with conductive carbon.

20. The lithium ion cell of claim 19, wherein the uncycled lithium ion cathode comprises:
A) i) a LMFP cathode active material; and
ii) a MFP cathode active material, a MNFP cathode active material, an FP cathode active material, an FCP cathode active material, an FMCP cathode active material, or any combinations thereof;
B) i) a LMNFP cathode active material; and
ii) a MFP cathode active material, a MNFP cathode active material, an FP cathode active material, an FCP cathode active material, an FMCP cathode active material, or any combinations thereof;
C) i) a LFP cathode active material; and
ii) a MFP cathode active material, a MNFP cathode active material, an FP cathode active material, an FCP cathode active material, an FMCP cathode active material, or any combinations thereof;
D) i) a LFCP cathode active material; and
ii) a MFP cathode active material, a MNFP cathode active material, an FP cathode active material, an FCP cathode active material, an FMCP cathode active material, or any combinations thereof; or
E) i) a LFMCP cathode active material; and
ii) a MFP cathode active material, a MNFP cathode active material, an FP cathode active material, an FCP cathode active material, an FMCP cathode active material, or any combinations thereof.

21. The lithium ion cell of claim 19, wherein the relative amounts of i) LMFP cathode active material, LMNFP cathode active material, LFP cathode active material, LFCP cathode active material, LFMCP cathode active material, or any combinations thereof; and ii) MFP cathode active material, MNFP cathode active material, FP cathode active material, FCP cathode active material, FMCP cathode active material, or any combinations thereof, are such that when the cathode is cycled in an electrochemical cell, the cell at its tenth cycle has a specific energy within 10% of the maximum theoretical specific energy of the cell.

22. The lithium ion cell of claim 14, wherein the electrolyte is a liquid or gel and the cell further comprises a separator between the cathode and the anode, wherein the separator is coated on one or both sides with a ceramic material.

23. A high capacity lithium ion cell comprising:
a high capacity anode of claim 1;
a bipolar lithium ion cathode comprising two different cathode active materials located in two distinct cathode layers on a single current collector,
wherein:
i) the two different cathode layers are disposed adjacent to one another, and the current collector is disposed adjacent to one cathode layer only;
ii) the current collector is disposed adjacent to and between the two different cathode layers;
iii) the two different cathode layers are both disposed adjacent to the current collector in different regions on a surface of the current collector; or
iv) the cathode comprises two layers each of the distinct cathode layers in which, on one side of the current collector, the two different cathode layers are disposed adjacent to one another and the current collector is disposed adjacent to a first type of cathode layer only and, on an opposite side of the current collector, two different cathode layers are disposed adjacent to cone another and the current collector is disposed adjacent to the first type of cathode layer only; and
wherein the two different cathode active materials are selected from: lithium nickel manganese cobalt oxide (NMC) in which nickel (Ni) is present in at least 50 wt % of the total weight of Ni, manganese (Mn), and cobalt (Co); lithium nickel cobalt aluminum oxide (NCA); lithium nickel manganese cobalt aluminum oxide (NMCA), lithium iron phosphate (LFP), lithium manganese iron phosphate (LMFP), lithium manganese nickel iron phosphate (LMNFP), lithium iron cobalt phosphate (LFCP), lithium iron manganese cobalt phosphate (LFMCP), and any combinations thereof; and
an electrolyte.

24. The lithium ion cell of claim 23, wherein:
the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co; or wherein x is such that Mn is present in an amount of up to 30 wt % of the total weight of the NMC;
the NCA has the general chemical formula LiNi_{1-x-y}CoₓAl_{y}O₂, wherein 0<x≤0.2 and 0<y≤0.2, or wherein 1−x−y is such that Ni is present in an amount of at least 50 wt % of the total weight of Ni, Co, and aluminum (Al);
the NMCA has the general chemical formula LiNi_{1-x-y-z}MnₓCo_{y}Al_{z}O₂, wherein 0<x≤0.2, 0<y≤0.2, and 0<z≤0.2, or wherein 1−x−y−z is such that Ni is present in an amount of at least 50 wt % of the total weight of Ni, Mn, Co, and Al;
the LFP has the general chemical formula LiFePO₄;
the LMFP has the general chemical formula LiFe₁₋ₓMnₓPO₄, wherein 0<x<1;
the LMNFP has the general chemical formula LiFe_{1-(x+y)}MnₓNi_{y}PO₄, wherein 0<x<1, 0<y<1 and x+y<1;
the LFCP has the general chemical formula LiFe₁₋ₓCoₓPO₄, in which 0<x<1; and
the LFCMP has the general chemical formula LiFe_{1-(x+y)}MnₓCo_{y}PO₄, in which 0<x<1, 0<y<1 and x+y<1.
